(19) United States
(12) Patent Application Publication
(10) Pub. No.: US 2009/0277973 A1
(43) Pub. Date: Nov. 12, 2009

(54) Apparatus for Vaporizing and Disbursing Liquid Scents and Method for Use Thereof

(76) Inventor: Rickey L. Kennon, Hernando, MS (US)

Correspondence Address: FRASCOGNA COURTNEY, PLLC, P.O.BOX 23126, JACKSON, MS, 39225-3126, US

(21) Appl. No.: 12/117,385

(22) Filed: May 8, 2008

(51) Int. Cl. B05B 17/00; A01M 31/00; B05B 1/24; A01K 15/04

(52) U.S. Cl. 239/13; 43/1; 119/712; 239/136; 239/569

(57) ABSTRACT

An apparatus for vaporizing and disbursing liquid scents and method for use thereof is disclosed. The present invention comprises both handheld and automatic sprayer embodiments that use heat to vaporize liquid scents and that disburse the scents into an area selected by the user. The present invention may be used by hunters for attracting potential game, business owners to attract customers, or by others to repel pests depending on the scent or scents used.

### FIELD OF THE INVENTION

This invention relates generally to scent dispensing devices and specifically to devices that disburse scents for to attract or repel animals.

### BACKGROUND OF THE INVENTION

Recreational hunters are constantly looking for methods to increase their success by attracting more game. One common method of attracting more game is to lure the game to the hunter by the use of a scent or scents. Many methods and devices exist to emit scents into the air in order to attract game.

By way of example, many deer hunters pour mixtures of deer urine or similar compounds onto leaves or on the ground in an effort to attract more deer to areas they intend to hunt. This method is limited in its effectiveness by the fact that the compounds only emit scent in a localized area.

Many other devices use heat in various ways to boil liquid scents in an effort to more effectively spread the vaporized scent particles. These devices have the disadvantage of spreading smells unevenly and unpredictably. Still other devices use fans or a combination of heat and fans to spread the scents in a directed path. These devices are disadvantageous because they make noise that can frighten potential game. Additionally, the scent disbursal devices currently available are designed to sit on the ground during operation. They are large, difficult to transport by hand to remote locations, and difficult to move in order to redirect the flow of the scent particles.

Therefore, what is needed is an apparatus which spreads scent in a wide area, is easily carried by hand, may be easily controlled during operation for an even distribution of scent, and does not make excessive noise during use. Furthermore, other desirable features and characteristics of the present invention will become apparent when this background of the invention is read in conjunction with the subsequent detailed description of the invention, appended claims, and the accompanying drawings.

### SUMMARY OF THE INVENTION

The present invention advantageously fills the aforementioned deficiencies by providing an apparatus for vaporizing and disbursing liquid scents and method for use thereof, hereinafter referred to as the “Buck Fogger,” which can spread scent into a wide area, can be easily carried by hand, can be controlled during use for an even scent disbursal, and does not make excessive noise. Additionally, the Buck Fogger can be used to spread scent designed to repel animals for farming or other purposes. The Buck Fogger may also be used to disburse scents that humans find attractive in order to advertise food or similar items.

The present invention now will be described more fully hereinafter with reference to the accompanying drawings, which are intended to be read in conjunction with both this summary, the detailed description, and any preferred and/or particular embodiments specifically discussed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

The drawings contained herein exemplify three of the embodiments of the claimed invention. It should be noted that the invention is not limited to the embodiments shown. The embodiments shown are purely examples, and the invention is capable of many variations of said embodiments. In the drawings,

FIG. 1 is a side view of the exterior of a first embodiment of the Buck Fogger.

FIG. 2 is a side cut away view of the first embodiment of the Buck Fogger.

FIG. 3 illustrates a side cut away view of a second embodiment of the Buck Fogger.

FIG. 4 illustrates a side cut away view of third embodiment of the Buck Fogger.

The first digit of each reference numeral in the above figures indicates the figure in which an element or feature is most prominently shown. The second digit indicates related elements or features, and a final letter (when used) indicates a sub-portion of an element or feature.

### DETAILED DESCRIPTION OF THE INVENTION

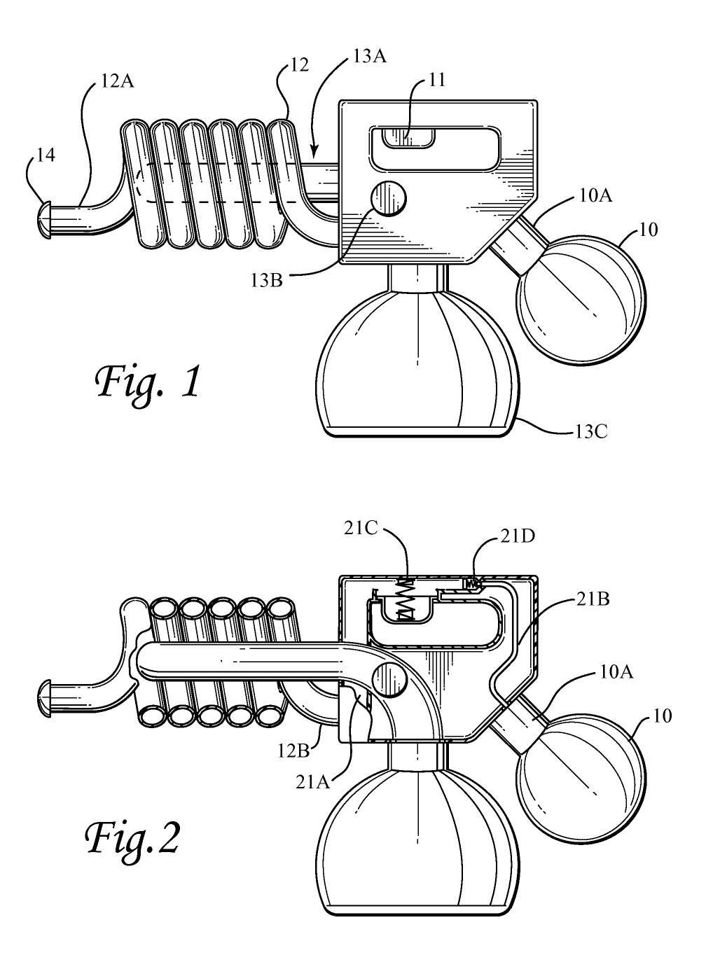

FIG. 1 illustrates a side view of the exterior a first embodiment of the Buck Fogger. This embodiment is designed to be hand held and operated. In this embodiment, liquid scent is stored in the scent reservoir 10.

In the preferred embodiment, the scent is any scent that may attract deer to a given location, including but not limited to, deer urine, synthetic deer urine, deer hormones, sweet potato scent, corn scent, food scents, or any other scent or combination of scents that may attract deer to a given location. In an alternate embodiment, the user may use alternate scents tailored to attract other types of animals such as squirrels, birds, turkey, quail, rabbit, elk, or other animals. In yet another embodiment, food scents may be used to attract customers to food service establishments. In this embodiment, the owner of a food service establishment may use scents that simulate baked breads, grilled meats, cooking chocolates, or any other food product that would draw customers into a store. In yet another embodiment, the user may select scents that repel deer. The user may also select scents that are known to repel other types of animals from a given area. In this embodiment, a farmer may use scents, either natural or synthetic, that certain animals find repulsive in order to prevent the animals from eating crops growing in gardens or rummaging in seed bins. The list of scents that may be used for varied applications is limited only by the imagination of the user.

The scent reservoir 10 further comprises an outlet 10A. The outlet 10A allows the liquid scent to be pumped out of the scent reservoir 10 and into the Buck Fogger. The flow of the liquid scent out of the scent reservoir is controlled by the control element 11. In this embodiment, the control element 11 comprises a manually operated trigger which the user presses repeatedly to pump the liquid scent from the scent reservoir 10 and into the heating chamber 12. The operation of the control element 11 is discussed in greater detail below.

Once pumped into the heating chamber 12, the liquid scent from the scent reservoir 10 is retained by the heating chamber 12 while being vaporized by the heat from the heating element 13. The heating chamber should be constructed from a material that can withstand heat created by the heating element 13 used in a given embodiment of the Buck Fogger. In the preferred embodiment, the heating chamber 12 is constructed in a coil shape. The coil shape helps retain the liquid scent while the scent is in the liquid phase. Also, the coil shape increases the surface area of the heating chamber 12 that is exposed to the heat from the heating element 13. A greater exposed surface area increases the efficiency of the vaporization process. However, many other shapes may be used to perform this function.

The function of the heating element 13 is to produce heat to vaporize the liquid scent retained in the heating chamber 12. The heat producing portion of the heating element 13 must be placed in close proximity to the heating chamber 12 to cause the vaporization of the liquid scent retained in the heating chamber 12. In this embodiment, the heating element 13 comprises a burner element 13A, a striking element 13B, and a fuel element 13C. The fuel element 13C supplies fuel to the burner element 13A, the heat producing portion of the heating element. The fuel element 13C also retains the fuel while the Buck Fogger is not in operation. The fuel element 13C should also be equipped with some valve to control the flow of fuel to the burner element 13A. In the present embodiment, the fuel used is propane, due to the fact that propane is easily available to most consumers. However, the present invention may use any fuel that burns at a temperature greater than the boiling point of the liquid scent to be vaporized.

In the present embodiment, the burner element 13A mixes air with the fuel from the fuel element 13C. After the air and fuel are mixed, the burner element 13A can maintain a combustion reaction. The heat created by the combustion reaction in the burner element 13A of the heating element 13 raises the temperature of the heating chamber 12, causing the liquid scent held in the heating chamber to vaporize. The striking element 13B is present to ignite the air and fuel mix to begin the combustion reaction in the burner element 13A.

When the liquid scent in the heating chamber 12 begins to vaporize, the air pressure in the heating chamber 12 will increase, forcing the scent vapor to move to the outlet 12A of the heating chamber 12. The outlet 12A of the heating chamber 12 is attached to a valve member 14. The valve member 14 comprises a small opening. The valve member 14 helps maintain the pressure in the heating chamber 12. The opening in the valve member 14 allows a compressed stream of scent vapor to leave the device and move toward the target area to be sprayed.

FIG. 2 is a side cut away view of a first embodiment of the Buck Fogger. FIG. 2 further discloses the manner in which the elements are connected. The liquid scent is moved from the scent reservoir 10 to the heating chamber 12 by a pumping element 21, which is responsive to the control element 11. The pumping element 21 further comprises an inlet 21B and an outlet 21A. The pumping element inlet 21B is connected to the scent reservoir outlet 10A. The pumping element outlet 21A is connected to the heating chamber inlet 12B. In the present embodiment, the pumping element comprises two one way valves. The primary valve 21C is directly responsive to the control element 11. The primary valve 21C compresses and then uncompresses the area inside the pumping element 21, causing liquid scent to move from the scent reservoir 10 into the pumping element 21. The secondary valve 21D prevents the liquid scent from reentering the scent reservoir 10. As the area inside the pumping element 21 is continually compressed and uncompressed by the control element 11, the liquid scent is forced into the heating chamber inlet 12B. The pumping element 21 in the present embodiment functions in the same manner as a standard household spray bottle. However, the pumping element 21 may instead comprise any device that can pump liquid from a reservoir and force the liquid into a connected area.

The embodiment described in FIG. 1 and FIG. 2 can be held in the user's hand. The user can initiate the heating element 13 by starting the flow of fuel to the burner element 13A and manipulate the striking element 13B to start a combustion reaction in the heating element 13 to create heat. The user can then manipulate the control element 11 to move liquid scent from the scent reservoir 10 to the heating chamber 12. The liquid scent will be vaporized and the valve member 14 will pressurize the scent vapor leaving the device. The user may then point the device at the targeted are and spray the scent. The scent will cover the targeted area and either attract or repel the intended game depending on the scent chosen as discussed above. The embodiment described in FIG. 1 and FIG. 2 is portable, lightweight, and useful for spraying remote areas.

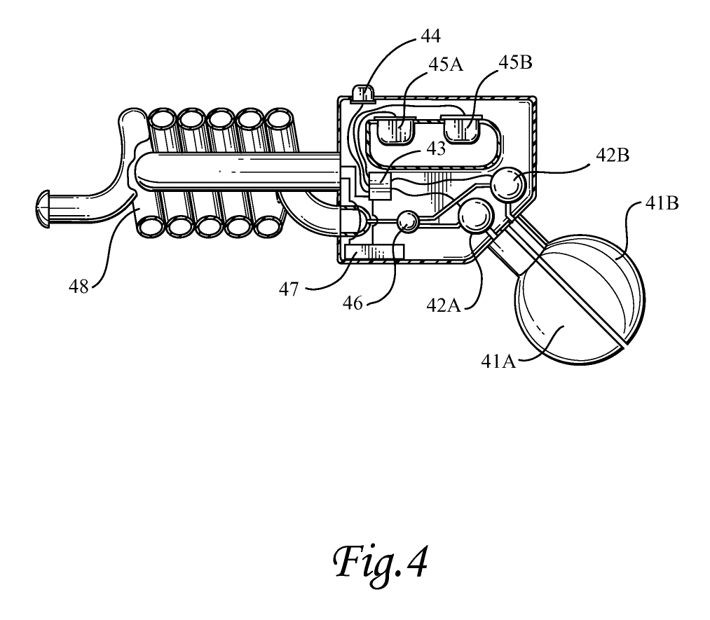

In an alternate embodiment, the scent reservoirs 10 may be subdivided into two or more scent reservoirs to contain multiple scents. In this embodiment, the device should contain one pumping element 21 for each scent reservoir used. The control element should also be capable of controlling the flow of each scent independently of the others. The device should also contain an element to mix the scents prior to vaporization in a manner similar to the mixing element 46 disclosed in the third embodiment as depicted in FIG. 4 and described more fully below.

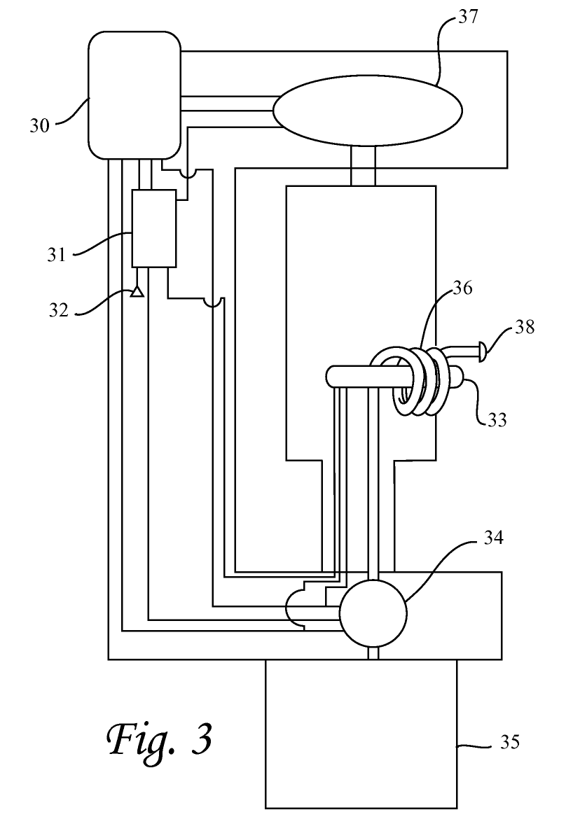

FIG. 3 illustrates a side cut away view of a second embodiment of the Buck Fogger. The present embodiment is designed to be placed at a fixed point and allowed to operate automatically by remotely transmitted commands or at specified intervals by instructions stored in the embodiment's memory. The present embodiment comprises a power source 30. In the preferred embodiment, the power source 30 is a rechargeable battery. Depending on the embodiment used, the power source 30 may instead comprise any unit that receives alternating current and outputs direct current at voltage levels appropriate for the other components in the embodiment. The power source 30 is electrically connected to the other components in the embodiment as discussed below.

The present embodiment also comprises a control element 31 electrically connected to the power source 30. In the preferred embodiment, the control element 31 comprises a microchip. The control element 31 receives input from the user and controls the other components of the device. The control element 31 may comprise a programmable clock. In that embodiment, the control element 31 may perform preprogrammed actions at a specified time or at specified intervals. The actions of the control element 31 are discussed in greater detail below.

The control element 31 is electrically connected to one or more receiver elements 32. In the preferred embodiment, the receiver element 32 is an antenna. The antenna is responsive to a remote control, and transmits commands encoded as electrical signals to the control element 31. The receiver element 32 may also comprise a panel on the exterior of the device, for inputting commands to the control chip. The user may then input commands by pressing the buttons on the panel. In an alternate embodiment, the receiver element 32 consists only of the panel.

Once the control element 31 receives input from the receiver element 32, the control element 31 may then control the device by sending the appropriate signals to the connected components. Because of the actions taken by the control element 32, the device will react immediately, at a specified time, or at specified intervals depending on the commands given.

The present embodiment comprises a heating element 33 electrically connected and responsive to the control element 31. The heating element 33 is also connected to the power source 30. The heating element 33 should be connected in such a way that said heating element 33 only receives power when given a signal by the control element 31. This operation may be accomplished by creating an open electrical connection between the heating element 33 and the power source 30 that is completed by the control element 31 or completed in response to a signal from the control element 31. In either case, upon the occurrence of the proper condition by the control element 31, the heating element 33 should be initiated and begin to produce heat. The production of heat may be accomplished by electrical resistance or any other method used to produce heat in an electric based heating system. The production of the heat by the heating element 33 starts the vaporization process in the same manner as in the non-automated embodiment.

The present embodiment comprises a pumping element 34 which forces liquid scent from the scent reservoir 35 and into the heating chamber 36 in a manner similar to that used in the previous non automated embodiment. The pumping element 34 is electrically connected to the power source 30 and the control element 31. The pumping element 34 comprises a pumping system, such as a motor driven pump, that pumps the liquid scent upon receiving a signal from the control element 31.

The present embodiment further comprises an orientation element 37. In the preferred embodiment, the orientation element 37 is a stepper motor. The orientation element 37 is electrically connected to the power source 30, and the control element 31. The orientation element 37 is physically connected to the heating chamber 36. Upon receiving the appropriate signal from the control element 31, the orientation element 37 turns the heating chamber 36, thereby changing the heating chamber's 36 orientation. Changing the orientation of the heating chamber 36 and the attached valve member 38 redirects the scent vapor spray to a different target area.

The overall operation of the present embodiment will now be summarized. The user may control the device by a remote control or through a panel. The commands will be transmitted from the receiver element 32 to the control element 31. The control element will interpret the signals based on said control element's 31 programming. At the appropriate time, based on the control element's 31 programming, the control element 31 will cause the pumping element 34 to force liquid scent retained in the scent reservoir 35 into the heating chamber 36. The control element 31 will also cause the heating element 33 to produce heat to begin the vaporization process in the heating chamber 36. The scent vapor will then leave the heating chamber 36 through the valve member 38. The control element 31 may also cause the orientation element 37 to turn to specific locations, in order to change the direction of the heating chamber 36, valve member 38, and the associated scent vapor spray. In this manner, the user may interact with the control element 31 to initiate the scent spray and the direction thereof.

FIG. 4 illustrates a side cut away view of a third embodiment of the Buck Fogger. This embodiment is a combination of the previous two embodiments. In present embodiment, the scent reservoir is subdivided into a first scent reservoir 41A and a second scent reservoir 41B. In this manner, the present embodiment can store two liquid scents at once. Alternate embodiments may also be created to store more scents and needed.

The present embodiment comprises a power source 47 that functions in the same manner as power source 30 as discussed above. The power source 47 may be any power source that can provide the power needed by the other components of this embodiment.

This embodiment also comprises a control element, further comprising a microchip 43, a first manually operated trigger 45A, a second manually operated trigger 45B, and a third manually operated trigger 44. The microchip 43 of the control element is electrically connected to the power source 47. The microchip 43 is also electrically connected and responsive to each of the manually operated triggers. The microchip 43 is also connected to the pumping element 42, the heating element, and may also be connected to the mixing element 46 each as described below. The microchip 43 receives input from the trigger elements and sends signal to control the other elements based on said microchip's 43 predetermined programming.

In the present embodiment, the pumping element 42 further comprises a first pumping element 42A and second pumping element 42B. The pumping elements each further comprise a pumping system, such as a motor driven pump, that moves the liquid scent upon receiving a signal from the control element. The first pumping element 42A is connected to the first scent reservoir 41A. The second pumping element 42B is connected to the second scent reservoir 42B. Both pumping elements are electrically connected and responsive to the microchip 43 of the control element. Both pumping elements are also electrically connected to the power source 47. When one of the pumping elements receives a signal from the microchip 43 of the control element, that pumping element pumps liquid scent from the scent reservoir to which said pumping element is attached and into the mixing element 46 as discussed below. In this manner, the present embodiment can move one or both liquid scents from the scent reservoirs 41 to the mixing element 46.

The present embodiment also comprises a mixing element 46. The mixing element 46 receives liquid scent from each of the pumping elements 42, mixes any liquid scent received, and allows the resultant mixture to pass into heating chamber 48, said heating chamber 48 having the same functionality as heating chamber 36 and heating chamber 12 used in previous embodiments. The mixing element may be any device that would perform the previously mentioned function. The mixing element 46 may be a simple device such as a three way connector or more complex such as an electrical mixing system. If an electric mixing system is employed, the mixing element 46 should be electrically connected to both the power source 47 and the microchip 43 of the control element and responsive to said microchip 43. The embodiment of mixing element 46 chosen should mix the liquid scents in predetermined ratios, depending on the desired composition of the scent spray.

As stated previously, the microchip 43 of the control element receives input from and is responsive to the first, second, and third manually operated triggers of the control element. When the first manually operated trigger 45A is pressed by the user, the trigger sends a signal to the microchip 43, which sends a signal to the first pumping element 42A to begin pumping liquid scent from the first scent reservoir 41A. In the same manner, when pressed, the second manually operated trigger 45B sends a signal to the microchip 43, which sends a signal to the second pumping element 42B to begin pumping liquid scent from the second scent reservoir 41B. The third manually operated trigger 44 sends a signal to the microchip 43 to send a signal to the heating element to start the vaporization process in the same manner as the previous embodiments.

The overall operation of the present embodiment will now be summarized. When the user presses the first manually operated trigger 45A, the second manually operated trigger 45B, or both, each pressed trigger sends a signal to the microchip 43. Depending on the signal or signals received, the microchip 43 sends a signal to the first pumping element 42A, the second pumping element 42B, or both. Any pumping element receiving a signal begins pumping liquid scent out of the scent reservoir to which said pumping element is attached. The liquid scent or scents are pumped into the mixing element 46. If two liquid scents are pumped into the mixing element 46, they are mixed in predetermined ratios. Additionally, the microchip 43 sends a signal to initiate the heating element to begin the vaporization process in the heating chamber 48. The scent mixture or scent from the mixing element 46 then enters the heating chamber 48 and is vaporized and spread in the same manner as in the previous embodiments. The power source 47 is connected to each component that needs power to function. It should be noted that FIG. 4 shows primarily the connections from the control element and omits many of the connections from the power source to the components. Those skilled in the art will understand that all components requiring electricity to function must be connected to the power source and a ground for the device to function as intended.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

I claim:

1. An apparatus for vaporizing liquid scent and disbursing the scent vapor into a target area, comprising:
a control element for controlling the flow of liquid scent inside the apparatus;
a plurality of scent reservoirs for storing liquid scent, each further comprising an outlet;
a plurality of pumping elements each further comprising an inlet and outlet, the inlet of each pumping element being connected to the outlet of a scent reservoir and the pumping elements being responsive to the control element, for forcing liquid scent from the outlet of a scent reservoir, through the inlet of a pumping element, and through an outlet of a pumping element;
a heating chamber further comprising an inlet and outlet, for receiving liquid scent from the outlet of a pumping element and for retaining the liquid scent during vaporization; and
a heating element positioned in proximity to the heating chamber, for raising the temperature of the liquid scent retained in the heating chamber to cause vaporization.

2. The apparatus of claim 1, further comprising a valve member attached to the outlet of the heating chamber for compressing the scent vapor leaving the heating chamber and entering a target area.

3. The apparatus of claim 1, wherein the heating element further comprises a fuel element connected to a burner element and a striking element.

4. The apparatus of claim 1, further comprising a power source electrically connected to the heating element to form an electric circuit for supplying electricity to said heating element.

5. The apparatus of claim 1, wherein the heating chamber comprises a coil shape.

6. The apparatus of claim 1, wherein the control element further comprises a microchip.

7. The apparatus of claim 1, wherein the control element further comprises a plurality of manually operated triggers.

8. The apparatus of claim 1, further comprising an orientation element electrically connected to the control element for redirecting the scent vapor to another target area.

9. The apparatus of claim 1, further comprising a mixing element connected to the outlets of a plurality of pumping elements and connected to the inlet of the heating chamber.

10. The apparatus of claim 1, further comprising liquid scent stored in the scent reservoir, wherein the liquid scent is selected to attract a specific type of animal.

11. The apparatus of claim 1, further comprising liquid scent stored in the scent reservoir, wherein the liquid scent is selected to repel a specific type of animal.

12. The apparatus of claim 1, further comprising liquid scent stored in the scent reservoir, wherein the liquid scent is selected to attract customers to food service establishments.

13. A method of vaporizing liquid scent and disbursing the scent vapor into a target area comprising
operating an apparatus for vaporizing scent and disbursing the scent vapor,
said apparatus comprising;
a control element for controlling the flow of liquid scent inside the apparatus;
a plurality of scent reservoirs for storing liquid scent, each further comprising an outlet;
a plurality of pumping elements each further comprising an inlet and outlet, the inlet of each pumping element being connected to the outlet of a scent reservoir and the pumping elements being responsive to the control element, for forcing liquid scent from the outlet of a scent reservoir, through the inlet of a pumping element, and through an outlet of a pumping element;
a heating chamber further comprising an inlet and outlet, for receiving liquid scent from the outlet of a pumping element and for retaining the liquid scent during vaporization; and
a heating element positioned in proximity to the heating chamber, for raising the temperature of the liquid scent retained in the heating chamber to cause vaporization;
said operation further comprising;
manipulating the control element to cause the pumping element to pump liquid scent from the scent reservoir into the heating chamber,
initiating the heating element,
allowing the liquid scent in the heating chamber to vaporize, and
aiming the apparatus into a target area.

14. The method of claim 13, wherein operation of the apparatus further comprises carrying the apparatus.

15. The method of claim 13, wherein the control element of the apparatus further comprises a microchip, and manipulating the control element of the apparatus is accomplished by transmitting signals to the control element.

16. The method of claim 15, wherein the apparatus further comprises an orientation element electrically connected to the control element, and aiming the valve member into a target area is accomplished by transmitting signals to the control element.

17. The method of claim 13, wherein the control element of the apparatus further comprises a microchip and initiating the heating element is accomplished by transmitting signals to the control element.

18. The method of claim 13, wherein the scent reservoir of the apparatus is filled with scent selected to attract a specific type of animal prior to operation.

19. The method of claim 13, wherein the scent reservoir of the apparatus is filled with scent selected to attract customers to food service establishments prior to operation.

20. The method of claim 13, wherein the scent reservoir of the apparatus is filled with scent selected to repel a specific type of animal prior to operation.
